(19) United States
(12) Patent Application Publication
(10) Pub. No.: US 2007/0272080 A1
(43) Pub. Date: Nov. 29, 2007

(54) Fuel vapor storage canister with foam volume compensator

(75) Inventors: Christopher D. Allen, Eastpointe, MI (US); James T. Dumas, Clinton Township, MI (US); Donald L. Gepper, Commerce Township, MI (US)

Correspondence Address: DAYCO PRODUCTS, LLC, 1 PRESTIGE PLACE, MIAMISBURG, OH, 45342, US

(73) Assignee: Dayco Products, LLC

(21) Appl. No.: 11/442,284

(22) Filed: May 25, 2006

(51) Int. Cl. B01D 53/02

(52) U.S. Cl. 96/134

(57) ABSTRACT

A fuel vapor storage canister comprising an elongate housing, an activated carbon bed, and a volume compensator of resilient, air-permeable foam. The foam volume compensator maintains the canister volume and the position of the activated carbon component, which enables proper adsorption of vapors in the fuel vapor storage canister.

### TECHNICAL FIELD

The present invention relates generally to fuel vapor storage canisters, and more specifically, to a fuel vapor storage canister having a volume compensator comprising an air-permeable, resilient polymeric foam.

### BACKGROUND

Fuel vapor storage canisters are standard pieces of automotive equipment used to reduce engine emissions. See U.S. Pat. No. 3,683,597, “Evaporation Loss Control” issued Aug. 15, 1972 to Thomas R. Beveridge and Ernst L. Ranft. The fuel vapor storage canister receives and stores fuel vapors emitted from the fuel tank of the engine. Generally, these canisters contain a vapor adsorbent media, usually activated carbon, usually in the form of activated charcoal. The canister is designed to receive the emitted fuel vapors, and to store these vapors. During engine operation, the stored fuel vapors may be purged from the fuel canister into the engine induction system for consumption within the engine. The greatest quantity of fuel vapor is emitted from the fuel tank immediately after engine shutdown. Vapors are also emitted from the fuel tank to the canister as a result of diurnal losses.

The basic design for fuel vapor storage canisters is well established. It includes an elongated canister housing often of generally rectangular cross section. The housing typically has a flexible construction, which can compensate for expansion caused by environmental conditions. A plastic or nylon housing is typical. The canister housing typically has several internal components including a fuel vapor adsorbent bed of packed activated carbon, an outlet carbon filter, and a volume compensator, which is located at the bottom of the canister housing.

Volume compensators serve two important functions in the fuel vapor canister. First, a volume compensator limits the shifting of the activated carbon particles in the carbon bed, which can cause the particles to erode. Because the canister frequently encounters vibration and other motion, ineffective packing of the carbon bed can result in shifting of the carbon particles, which produces surface erosion. As carbon particles erode against each other flow paths may be left behind through which hydrocarbons can escape without being adsorbed. Accordingly, volume compensators are used to ensure tight packing in the carbon bed and thereby limit the effect of vibration in the carbon bed. Second, the volume compensator helps maintain the internal area of the carbon bed as the canister body expands or contracts due to temperature changes. Changes in the internal area of the carbon bed can also result in the shifting or erosion of the carbon particles. Accordingly, volume compensators are used to minimize the effect of thermal expansion by resiliently compacting the carton bed.

The design of volume compensators has undergone many modifications over the past 40 years. Early fuel vapor storage canisters did not include a volume compensator. An early embodiment of a volume compensator was an assembly of two molded trays separated by springs. See U.S. Pat. No. 5,098,453, “Vapor Storage Canister with Volume Change Compensator” issued Mar. 24, 1992 to Turner et al. The current volume compensators typically include a plastic separator or grid, filter media (usually a closed pore polyester foam), springs, and a screen to prevent the carbon from penetrating into the filter media. The springs are used to compensate for the changes in carbon volume during vehicle operation. See U.S. Pat. No. 6,551,388, Volume Compensator Assembly for Vapor Canister to Oemcke et al.

### SUMMARY

The present invention uses an air-permeable, resilient, polymeric foam, rather than a mechanical spring, as a volume compensator. In one embodiment, the foam is an open pore foam, also referred to as an open cell foam.

### BRIEF DESCRIPTION OF THE DRAWINGS

FIG. 1 is a cross-sectional view of a prior art fuel vapor canister with multi-component volume compensator.

FIG. 2 is a cross-sectional view of a fuel vapor canister in accordance with one embodiment of the present invention.

FIG. 3 is a schematic cross-sectional view of an open pore polyurethane foam utilized in the preferred embodiment of the present invention.

### DETAILED DESCRIPTION

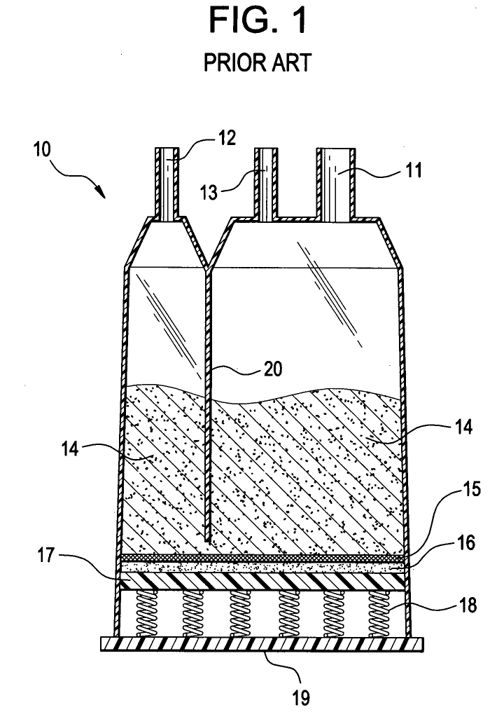

FIG. 1 illustrates a prior art fuel vapor canister with a multi-component volume compensator. At the top of the canister 10 is a first tube 11 connected to a fuel tank, a second tube 13 connected to a purge line, and a third tube 12 that vents to the atmosphere. The tube 11 delivers air-containing fuel vapors from the fuel tank to an activated carbon medium 14 within the canister 10. During engine operation, the fuel vapors may be purged from the fuel canister 10 to the engine through the tube 13. The activated carbon medium 14 is supported and compacted by a multi-component volume compensator, which may include a metal screen 15, a filter media 16, a plastic grid 17, and springs 18. In addition, there is an end plate 19 located on the bottom of the canister 10 for canister sealing. A partition or baffle 20 may be placed in the canister to prevent vapors from passing out tube 12 without first circulating through the carbon bed 14 for absorption.

The metal screen 15 and filter media 16 form a movable base that contains and compacts the carbon in the activated carbon medium 14. The grid 17 provides a rigid surface against which the springs 18 can exert a compaction force. In conventional fuel vapor canisters, the filter media 16 may be a closed pore or high density open pore polyurethane and the screen 15 may be a fine metal mesh screen. The plastic grid 17 may be any rigid material including plastic and the springs 18 may be mechanical springs such as helical wire compression springs. Some manufacturers of the volume compensator device leave out the screen and/or filter media altogether.

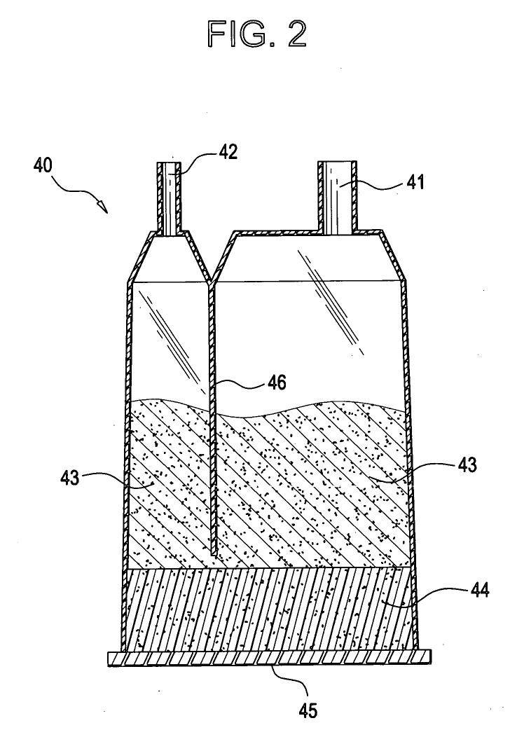

FIG. 2 illustrates a structure in accordance with one embodiment of the present invention. The canister housing 40 includes inlet 41 and outlet 42 tubes, an activated carbon medium 43, a foam volume compensator 44, an end plate 45 and a partition 46. Air containing fuel vapors may be delivered to the carbon medium 43 and purged to the engine for consumption through tube 41. In another embodiment, separate inlet and purge lines may be used as in the prior art device.

The foam 44 is resilient and maintains the positioning of the activated carbon medium 43 inside the canister housing 40. When the foam 44 is compressed, the foam 44 provides a compaction force that acts against the activated carbon medium to stabilize the medium 43 as discussed above. Furthermore, the foam 44 is air-permeable to facilitate airflow through the canister and minimize pressure drops.

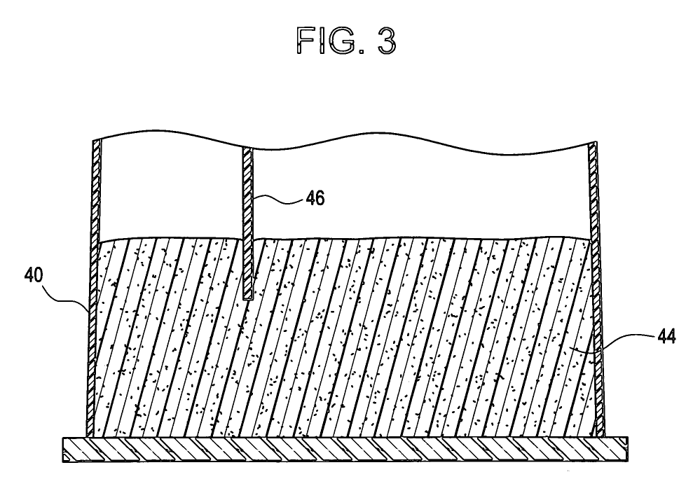

FIG. 3 provides an enlarged schematic view of an open pore foam used in the fuel vapor storage canister in one embodiment of the invention. Preferably, the foam is a low density open pore polyurethane foam. As depicted in FIG. 3, the open pore structure provides numerous flow paths through the foam resulting in good air-permeability. The foam can be fabricated with various pore sizes, which enables the foam to be useful in numerous applications. Pore sizes may range from about 25 to 65 ppi. The versatility of pore size and the open pore structure enables the foam to control permeability and airflow. Low density open pore foams provide increased permeability over the closed pore and high density open pore foams employed in the prior art. Further, the foam also provides other functionality such as filtering, sound/absorption, vibration dampening, etc. While polyurethane foams are desirable because of their chemical resistance and mechanical/elastomeric properties, those skilled in the art will recognize other commercially available foams may be used.

In the fuel vapor storage canister, the pore size of the foam used will depend on the carbon medium characteristics. The invention incorporates 35 ppi foam in one embodiment in which 2 mm pelletized carbon is used in the canister, and utilizes 65 ppi foam in one embodiment when 18×36 mesh granular carbon is used.

The variety of pore sizes in which the polyurethane foam is available provides fabrication and manufacturing versatility. In one embodiment the polyurethane foam has a density of about 1.7 to 2.1 lbs/ft3 and an indentation force deflection (IFD) of greater than or equal to 60 lbs. Indentation force deflection is defined herein as the pounds of force necessary to compress a foam sample 25%, i.e., to 75% of its original thickness. One example of suitable foams are the flexible polyurethane foams produced by FOAMEX.

The resiliency of the polyurethane foam 44 facilitates the stabilization of the carbon medium 43 in the fuel vapor storage canister housing 40. During assembly of the canister, the foam is compressed between the end plate 45 and the carbon bed 43 to approximately 40 to 60% of its original thickness. In response, the foam exerts an opposing compression or compaction force on the carbon bed. This opposing force minimizes the effect of vibration and thermal expansion and contraction.

All documents cited are, in relevant part, incorporated herein by reference. The citation of any document is not to be construed as an admission that it is prior art with respect to the present invention. While particular embodiments of the present invention have been illustrated and described, it would be obvious to those skilled in the art that various other changes and modifications can be made without departing from the spirit and scope of the invention.

What is claimed is:

1. A fuel vapor storage canister comprising:
a housing having a vapor inlet and a vent to the atmosphere;
an activated carbon bed within the housing; and
a volume compensator comprising an air-permeable, resilient foam that is compressed so as to exert a compaction force on the carbon bed in the housing.

2. The canister of claim 1 wherein the foam is a polymeric foam.

3. The canister of claim 2 wherein the foam is an open pore polyurethane foam.

4. The canister of claim 3 wherein the foam has a density of about 1.7 to 2.1 lbs/ft³.

5. The canister of claim 3 wherein the foam has a pore size of about 25 to 65 ppi.

6. The canister of claim 1 wherein the foam has an indentation force deflection of ≧50 lbs.

7. The canister of claim 6 wherein the foam has an indentation force deflection of ≧60 lbs.

8. The canister of claim 1 wherein the volume compensator exerts a compaction force on the carbon bed without the use of mechanical springs.

9. A fuel vapor storage canister comprising:
a housing having a vapor inlet and a vent to the atmosphere;
an activated carbon bed within the housing; and
a volume compensator consisting essentially of air-permeable, resilient foam that is compressed so as to exert a compaction force on the carbon bed in the housing.

10. A fuel vapor storage canister comprising:
a housing having a vapor inlet and a vent to the atmosphere;
an activated carbon bed within the housing; and
a volume compensator comprising a resilient foam that is compressed between the carbon bed and the housing so as to exert a compaction force on the carbon bed.

11. The canister of claim 10 wherein opposing sides of the foam are touching the carbon bed and the housing, respectively.
